(19) United States
(12) Patent Application Publication
(10) Pub. No.: US 2019/0283294 A1
(43) Pub. Date: Sep. 19, 2019

(54) HOLLOW PROFILE COMPOSITE TECHNOLOGY

(71) Applicant: LANXESS Deutschland GmbH, Koln (DE)

(72) Inventor: Boris KOCH, Wermelskirchen (DE)

(73) Assignee: LANXESS Deutschland GmbH, Koln (DE)

(21) Appl. No.: 16/285,800

(22) Filed: Feb. 26, 2019

(30) Foreign Application Priority Data
Mar. 14, 2018 (EP) 18161710.1

(51) Int. Cl. B29C 45/14; B29C 45/17; B29C 43/18

(52) U.S. Cl. CPC B29C 45/14409; B29C 43/18; B29C 45/1703; B29C 45/14598

(57) ABSTRACT

Systems and processes produce a plastic-metal composite component composed of at least one hollow profile and at least one fluid to be used in an interior of the at least one hollow profile.

This application claims foreign priority benefit of European Application No. EP 18161710.1, filed Mar. 14, 2018, the disclosure of which patent application is incorporated herein by reference.

The invention relates to a process for producing a plastic-metal composite component composed of at least one hollow profile and at least one fluid to be used in the interior of the at least one hollow profile.

Even now, there are many cases of use of composite components in motor vehicle construction. They are usually produced from a metallic tubular profile and a metallic closed hollow profile that are bonded to at least one separately produced plastic element. The production of two separate components, a metallic tubular or hollow profile and a plastic element, and finally the bonding of these at least two components leads to an elevated level of manufacturing and assembly complexity. For bonding of a tubular or hollow profile to one or more plastic element(s), moreover, additional bonding means in the form of screws, nuts, rivets or the like are required, which in turn generally requires more construction space and leads to higher weight of the composite component to be produced.

Comparable composite components consisting of plastic alone—i.e. both hollow profile and plastic element(s) are made of plastic—given acceptable dimensions of the cross sections, show lower strengths and stiffnesses, but also disadvantages in the absorption of energy under abrupt stress, compared to equivalent components made of metallic materials.

### PRIOR ART

WO 2009/077026 A1 relates to a process for producing a composite component from a profile and an injection-molded element, wherein the injection-molded element is molded onto the profile, such that the profile is captively gripped in the peripheral direction and at least one form-fitting element is formed on the profile and is included in the injection-molding operation in that the form-fitting element between the ends of the profile is shaped or molded in a restricted manner in terms of peripheral direction and longitudinal extent.

A disadvantage of the process of WO 2009/077026 A1 is the very complex and costly mechanical bonding of injection-molded plastic component and the profile. Since, according to WO 2009/077026 A1, a hydroforming method (HF) is employed in a combination mold prior to the injection molding process, there is inevitably a limitation to the process with regard to the minimum dimension of the wall thickness of the profile, which opposes a reduction in weight for the purpose of modern lightweight construction. Moreover, a restriction arises with regard to shear stiffness and shear resistance of the bond of injection-molded component to the profile. Since, moreover, the bonding of the two components is based on a form fit, this bond can only be executed by means of insert molding around the profile in the form of a ring, referred to in WO 2009/077026 A1 as circumferential lamella. However, the breadth of such a circumferential lamella is limited since there can otherwise be unwanted high deformation of the profile wall during the HF, extending as far as bursting thereof. An increase in the bond stiffness or bond strength of profile and injection-molded component can therefore be achieved in WO 2009/077026 A1 only by means of an arrangement of multiple circumferential lamellae of this kind across the profile, it being necessary to observe a minimum distance of several millimeters between the circumferential lamellae. According to WO 2009/077026 A1, this distance is generated by cores. If, however, the width of these cores is too small, there is a risk of core breakage and the bursting of the profile since, with use of HF, the tube wall of the profile used in tubular form is both radially extended and axially shifted on the engraved pattern, and the profile at the same time has to be supported across a maximum area. According to WO 2009/077026 A1, it is therefore possible, for a profile area X=100%, to coat only an average proportion of 50% at most with plastic by in-mold coating.

WO 2005/002825 A1 describes a process for producing a plastic-metal composite component at least consisting of a hollow body made of metal or plastic and having at least one opening and to which thermoplastic is applied by injection molding and/or which is subjected to partial or complete insert molding with thermoplastic, wherein the hollow body is completely filled with an incompressible liquid in the course of injection molding and/or insert molding. WO 2005/002825 A1 does not disclose any solution with regard to the handling of the tolerance problems with a hollow profile for use in accordance with the invention for production of plastic-metal composite components according to the invention. An oversize hollow profile manufactured according to WO 2005/002825 A1 would not be insertable in a force-free or resistance-free manner into a cavity of an injection mold or compression mold for use in accordance with the invention, and on closure of said injection mold or compression mold would lead to damage either to the hollow profile itself or to the injection mold or compression mold. In the case of too small a hollow profile manufactured according to WO 2005/002825 A1, plastics melt would be applied to the hollow profile in unwanted regions. The problems of the manufacturing tolerances in the hollow profile for use in accordance with the invention are thus not addressed in WO 2005/002825 A1. Manufacture of plastic-metal composite components in a manner suitable for the industrial scale cannot be conducted or assured by the process according to WO 2005/002825 A1.

EP 2604407 A1 describes an injection molding process for production of a tube connection, consisting of a tubular thermoplastic component and at least one functional element made of a thermoplastic material compatible therewith. In order to prevent deformation of the thermoplastic tube when the functional element is applied by injection molding, a wide variety of different fillers or filler elements are introduced within the tube, and these are removed again after the injection molding operation. The problems of the manufacturing tolerances in a hollow profile for use here are not addressed in EP 2604407 A1. Manufacture on the industrial scale cannot be assured by the process according to EP 2604407 A1.

The problem addressed by the present invention was therefore that of providing a process for producing plastic-metal composite components, in which a thin-walled, metal-based hollow profile is introduced into an injection mold or compression mold with sufficient play and in a resistance-free manner and at the same time sealing of at least one cavity for an application of plastic to be applied to the hollow profile and any distribution thereof around the hollow profile is achieved, the application of plastic to be applied or which is ultimately applied is additionally bonded to the outside of the hollow profile without deforming the overall outer shape thereof, which gives rise to a radial or else axial form-fitting, mechanically stiffer and more highly durable composite component in the form of a plastic-metal composite component than can be produced according to the above-cited prior art.

In addition, the problem addressed by the present invention was that of bonding hollow profiles that are subject to tolerances from a wide variety of different origins and made of a wide variety of different materials in one and the same injection molding or compression process to plastic functional element(s) in defined regions, wherein the hollow profile is introduced into an injection mold or compression mold in a force-free or resistance-free manner rotated by 90° by its longitudinal axis relative to closure direction and the hollow profile within the mold undergoes reliable radial sealing of its circumferential face at the axial ends of the injection molding or compression molding cavity in order to prevent application of plastic in axial direction in regions where no application of plastic is intended.

Composite components to be produced in accordance with the invention should additionally not have any disadvantages in terms of manufacture, any disadvantages in terms of strength and stiffness properties and even any disadvantages in terms of energy absorption characteristics, and should also enable a high degree of functional integration for the purposes of system or module formulation in economically viable manufacture.

### SUMMARY OF THE INVENTION

The object is achieved by a process for producing a plastic-metal composite component, especially with a shear-resistant and form-fitting bond of the metal component and plastic component, by
a) providing an injection mold or compression mold with at least one openable cavity and a mold dimension A in closure direction and a mold dimension B at right angles to the closure direction of the mold and a cavity circumference UW corresponding to the circumference of the cavity in the region of mold dimensions A and B, with at least two slide gates or at least two core pullers, arranged in such a way that the two open ends of the hollow profile are closed by the travel of the at least two slide gates or at least two core pullers, or the closure elements that are to be provided in process step c) and introduced into the open ends in process step d) are blocked from being pushed away from the open ends of the hollow profile by the plastic to be applied in process step j),
b) providing at least one hollow profile made of metal with a ratio of diameter to wall thickness in the range from 5:1 to 300:1, the outer dimension C of which is greater by a range of 0.1% to 5% than the mold dimension A, and the outer dimension D of which is smaller by a range of 0.1% to 5% than the mold dimension B, and the figures for C and D are based on 90° viewed in the direction toward the longitudinal axis of the hollow profile, and the hollow profile circumference UH of which corresponds to the cavity circumference UW of the at least one injection mold or compression mold cavity specified in a),
c) providing at least two closure elements,
d) introducing the closure elements provided in c) and hence sealing the two open ends of the hollow profile,
e) introducing a fluid through openings into the at least one hollow profile that has been sealed after d) through at least one of the closure elements and deaerating the interior of the hollow profile,
f) inserting the hollow profile that has been sealed after e) into the at least one cavity of the injection mold or compression mold provided in a),
g) supporting the at least two closure elements that close the two ends of the hollow profile by means of the slide gates or core pullers on the mold side,
h) closing the at least one cavity of the injection mold or compression mold and pressing the hollow profile by the mold closure movement in closure direction of the at least one cavity to change the shape of the hollow profile in that the outer surface of the hollow profile, after the end of the mold closure operation, corresponds to the inner shape of the cavity of the injection mold or compression mold provided in process step a) in the region of the contact surfaces at the axial ends of the at least one cavity, while the hollow profile circumference UH remains equal to the cavity circumference UW,
i) locking the slide gates or core pullers and hence simultaneously blocking the at least two closure elements provided in process step c) from being pushed away from the open ends of the hollow profile by the plastic to be applied in process step j),
j) externally applying an application of plastic in the form of a melt at a pressure in the range from 1 bar to 1000 bar to the hollow profile, preferably in the range from 10 bar to 500 bar, more preferably in the range from 50 bar to 300 bar,
k) cooling the application of plastic applied to the hollow profile in i) (solidification),
l) removing the finished composite component from the injection mold or compression mold, and
m) removing the closure elements and emptying the fluid out of the hollow profile provided with the application of plastic.

Surprisingly, the process according to the invention permits, by virtue of the mold dimensions A and B described in process steps a) and b) and the hollow profile dimensions C and D that have been matched thereto and are described in process step b), insertion of the hollow profile into the injection mold or compression mold with sufficient play and nevertheless achieves, with the proviso of equal cavity circumferences UW and hollow profile circumferences UH, on closure of the at least one cavity of the injection mold or compression mold, sealing of the at least one cavity for an application of plastic to be applied to the hollow profile and any distribution thereof about the outer surface of the hollow profile in process step j), with no change in volume in the interior of the hollow profile.

“Sufficient play” in the context of the present invention means that the minimum dimension of the injection mold or compression mold cavity, viewed at right angles to the closure direction of the mold, is greater than, or in the boundary case even equal to, the external dimension of the hollow profile cross section that is subject to tolerances, likewise viewed at right angles to the closure direction of the mold. Preferably, therefore, the smallest dimension of the injection mold or compression mold cavity is in the range from 100% to 105% of the external dimension of the hollow profile cross section, especially 100%, in each case viewed at right angles to the closure direction of the mold.

Surprisingly, the inserting of the hollow profile into the injection mold or compression mold with provision of sufficient play and the sealing of the at least one cavity for an application of plastic to be applied to the hollow profile and any distribution thereof over the outer face around the hollow profile work even when the hollow profile circumference UH deviates by up to +5% compared to the cavity circumference UW of the injection mold or compression mold. This is because, in this case, the interior of the hollow profile undergoes a slight reduction in volume, the effect of which is that the closure elements are pushed away from the open ends of the hollow profile by the fluid present within the interior against the resistance offered by the slide gates or core pullers. Since, however, the slide gates or core pullers permit such a movement during the closure of the injection mold or compression mold and lock only thereafter, they work equally well when the hollow profile circumference UH corresponds to the cavity circumference UW of the injection mold or compression mold.

Surprisingly, the process according to the invention therefore permits the production of plastic-metal composite components from a metal-based hollow profile and a fluid that acts against the spray pressure in the interior of the thin-walled hollow profile with an application of plastic applied to the outside of the hollow profile in an injection mold or compression mold without the use of an operation on the mold or the use of an internal high pressure to be employed additionally according to the prior art in order to establish a seal between the hollow profile which is subject to tolerances and is for use in accordance with the invention and the injection mold or compression mold, but at the same time to provide sufficient support in such a way that the application of plastic applied is bonded to the hollow profile in a form-fitting, shear-resistant and shear-stiff manner, in that, of an outer surface section of the hollow profile of X=100%, more than 50%, preferably 75% to 100%, more preferably 90% to 100%, is bonded to plastic, preferably by application by injection molding, insert molding, in-mold coating, application by compression molding or insert compression molding. According to the invention, the sealing to the at least one cavity of the injection mold or compression mold is effected by means of the hollow profile itself.

According to the invention, the metal-based hollow profile has to be filled with a fluid prior to the application of plastic. However, this measure does not lead to an added weight for the plastic-metal composite component as process product because the fluid is removed again from the hollow profile after the application of plastic.

According to the invention, surprisingly, a form-fitting bond in the form of a hybrid component is achieved by insert molding of the metal-based hollow profile with plastic, with blocking of the following degrees of freedom:
radially in all directions about the center axis of the hollow profile,
rotationally at right angles to the center axis of the hollow profile.

Additional blocking in a rotational manner about the center axis and in a translational manner in the direction of the center axis of the hollow profile, in a further preferred or alternative embodiment, requires a form-fitting or adhesive bond of hollow profile and application of plastic by means of a surface treatment of the outer surface of the hollow profile. Such a surface treatment is preferably effected at least prior to process step c). As a result, blocking of all degrees of freedom is achieved, translationally in X, Y and Z direction and rotationally about the X, Y and Z axis. Preferred forms of surface treatment are the application of at least one adhesion promoter, plasma surface activation, laser structuring, chemical pretreatment or an additive manufacturing process.

Preferred means of chemical pretreatment are the use of acids or bases. A preferred additive manufacturing process is the thermal metal spray application process. See: htttps://de.wikipedia.org/wiki/Thermisches_Spritzen.

In a further preferred or alternative embodiment, the hollow profile to be provided in process step b) has structural elements, preferably fins, on its outside, which, after the application of plastic in process step j) and the cooling in process step k), form a form-fitting connection/interdigitation with the blocking of all degrees of freedom, translationally in X, Y and Z direction and rotationally about the X, Y and Z axis and hence additionally form a shear-resistant and shear-stiff bond at least in axial direction, preferably in axial and radial direction, based on the hollow profile.

For clarification, it should be noted that all definitions and parameters adduced, mentioned in general terms or within areas of preference, are encompassed in any and all combinations. Standards cited in the context of this application are considered to mean the version in force at the filing date.

Compression in process step h) means deformation of the hollow profile in which no increase in the extent of the hollow profile circumference UH is brought about, merely a change in shape. In the event of a tolerance-related oversize of the hollow profile circumference, a change in shape is preferably brought about, associated with minor compression or reduction in the circumference of the hollow profile circumference UH toward the end of the mold closure movement.

Shear strength is a physical constant that describes the resistance offered by a material to being sheared away, i.e. to separation by forces that attempt to move two adjoining faces in the longitudinal direction. Shear strength is determined by the shear modulus, also called modulus of rigidity. In the context of the present invention, “bonded to one another in a shear-resistant manner” means a form-fitting bond of the hollow profile to at least one application of plastic applied to the hollow profile, said bond being shear-resistant in axial direction, preferably in axial and radial direction, of the hollow profile.

Shear stiffness is the product of the shear modulus G of a material and the cross-sectional area AA:
Shear stiffness=G·A·κ(=G·Aₛ)

The cross section-dependent correction factor κ takes account of the inhomogeneous distribution of shear stress [symbol] over the cross section. Shear stiffness is also often expressed in terms of the shear area Aₛ. See: htttps://de.wikipedia.org/wiki/Steifigkeit.

Form-fitting bonds in the context of the present invention arise through the intermeshing of at least two bonding partners that enter into an inextricable bond with one another and are only separated from one another again by destruction. See: htttps://de.wikipedia.org/wiki/Verbindungstechnik.

### PREFERRED EMBODIMENTS OF THE INVENTION

In an alternative or preferred embodiment, the hollow profile is filled with the fluid and/or the fluid is emptied out of the hollow profile prior to process step j) in the injection mold or compression mold.

In an alternative or preferred embodiment, process steps d) and e) are conducted within the injection mold or compression mold. In this case, the closure elements are part of the injection mold or compression mold in the form of slide gates or core pullers which, in this case, seal the hollow profile which is still open on both sides in process step f).

Preferably, a fluid is introduced until 100% of the volume of the interior of the hollow profile has been filled therewith.

Preferably, a hollow profile for use in accordance with the invention, apart from the openings to be closed by closure elements at the top ends, does not have any further openings in the form of bores or holes to ensure that the fluid cannot leak.

In a further preferred or alternative embodiment, after process step l), the hollow profile is deformed at at least one position by the action of additional flexural forces at positions where there is no application of plastic. Preferably, additional flexural forces are allowed to act when the final composite component shape differs from the shape of a hollow profile to be provided in process step b), preferably in straight tube form.

In a further preferred or alternative embodiment, before process step d), the hollow profile is deformed at at least one position by the action of additional flexural forces. This deforming can be conducted outside the injection mold or compression mold at any position in the hollow profile. Preferably, it is possible here too to allow additional flexural forces to act when the final composite component shape differs from that of a straight hollow profile.

The invention preferably relates to a process for producing a plastic-metal composite component, especially with a shear-resistant and form-fitting bond of the metal component and plastic component, by
a) providing an injection mold or compression mold 5 with at least one openable cavity and a 7 mold dimension A in closure direction and a 8 mold dimension B at right angles to the closure direction of the mold and a 9 cavity circumference UW corresponding to the circumference of the cavity in the region of mold dimensions A and B, with at least two slide gates or at least two core pullers 23, arranged in such a way that the two open ends of the hollow profile are closed by the travel of the at least two slide gates or at least two core pullers, or the closure elements 18 that are to be provided in process step c) and introduced into the open ends in process step d) are blocked from being pushed away from the open ends of the hollow profile by the plastic 2 to be applied in process step j),
b) providing at least one hollow profile 1 made of metal with a ratio of diameter to wall thickness in the range from 5:1 to 300:1, the 10 outer dimension C of which is greater by a range of 0.1% to 5% than the 7 mold dimension A, and the 11 outer dimension D of which is smaller by a range of 0.1% to 5% than the 8 mold dimension B, and the figures for C and D are based on 90° viewed in the direction toward the longitudinal axis 3 of the hollow profile 1, and the 12 hollow profile circumference UH of which corresponds to the 9 cavity circumference UW of the at least one injection mold or compression mold cavity specified in a),
c) providing at least two closure elements 18,
d) introducing the closure elements 18 provided in c) and hence sealing the two open ends of the hollow profile 1,
e) introducing a fluid through openings 22 into the at least one hollow profile 1 that has been sealed after d) through at least one of the closure elements 18 and deaerating the interior of the hollow profile 1,
f) inserting the hollow profile 1 that has been sealed after e) into the at least one cavity of the injection mold or compression mold 5 provided in a),
g) supporting the at least two closure elements 18 that close the two ends of the hollow profile 1 by means of the slide gates or core pullers 23 on the mold side,
h) closing the at least one cavity 24 of the injection mold or compression mold 5 and pressing the hollow profile 1 by the mold closure movement in closure direction 6 of the at least one cavity 24 to change the shape of the hollow profile in that the outer surface of the hollow profile 1, after the end of the mold closure operation, corresponds to the inner shape of the cavity of the injection mold or compression mold 5 provided in process step a) in the region of the contact surfaces 4 at the axial ends of the at least one cavity, while the 12 hollow profile circumference UH remains equal to the 9 cavity circumference UW,
i) locking the slide gates or core pullers 23 and hence simultaneously blocking the at least two closure elements 18 provided in process step c) from being pushed away from the open ends of the hollow profile 1 by the plastic 2 to be applied in process step j),
j) externally applying an application of plastic 2 in the form of a melt at a pressure in the range from 1 bar to 1000 bar to the hollow profile 1, preferably in the range from 10 bar to 500 bar, more preferably in the range from 50 bar to 300 bar,
k) cooling the application of plastic 2 applied to the hollow profile 1 in i) (solidification),
l) removing the finished composite component from the injection mold or compression mold 5, and
m) removing the closure elements 18 and emptying the fluid out of the hollow profile 1 provided with the application of plastic.

Process Step a)

Process step a) relates to the providing of an injection mold or compression mold with at least one openable cavity and a mold dimension A in closure direction and a mold dimension B at right angles to the closure direction of the mold. According to the invention, the closure direction relates to the injection mold or compression mold to be used. Preferably, an injection mold or compression mold for use in accordance with the invention has two mold halves. According to the configuration of the composite component to be manufactured, however, the mold halves may in turn consist of multiple segments. The person skilled in the art will adapt the design of the injection mold or compression mold to be used in accordance with the composite component to be manufactured. A summary of injection molds or compression molds for use in accordance with the invention and of manufacturers thereof can be found, inter alia in W. Michaeli, G. Menges, P. Mohren, Anleitung zum Bau von Spritzgießwerkzeugen [How to Make Injection Molds], 5th fully revised edition, Carl Hanser Verlag Munich Vienna 1999 (English edition 2001).

Preferably, an injection mold or compression mold for use in accordance with the invention has the following features in order that a hollow profile for use in accordance with the invention with all its dimensional and shape tolerances can be inserted without force into the injection mold or compression mold:
aI. The injection mold or compression mold has to be such that it seals the injection molding or compression molding cavities with respect to the regions of the hollow profile in which there is no application of plastic in process step e) on closure of the mold. For this purpose, the injection mold or compression mold needs, at the axial ends of the injection molding or compression molding cavities, contact faces in the mold that compress the hollow profile during the closure of the mold from its outer hollow profile dimension C to the mold dimension A, which simultaneously alters the outer hollow profile dimension D to the mold dimension B, and where the hollow profile circumference UH remains identical to the cavity circumference UW of the at least one injection mold or compression mold cavity,
aII. In one embodiment, the contact faces of the at least two mold halves with respect to the hollow profile in the injection mold or compression mold are executed such that a greater hollow profile circumference UH by up to +5% over and above the compression described in aI. is additionally pressed onto the same cavity circumference UW, described in aI., of the at least one injection mold or compression mold cavity;
aII. The contact faces of the at least two mold halves in the injection mold or compression mold that have been mentioned in aI. and aII., with the mold closed, enclose the hollow profile over its entire extent and preferably have a width, i.e. an extent viewed in the axial direction of the hollow profile, in the range from 1.0 to 50.0 mm, preferably 3.0 to 25.0 mm, more preferably 5.0 to 10.0 mm;
aIV. In one embodiment, the contact faces of the at least two mold halves with respect to the hollow profile in the injection mold or compression mold are executed such that these regions in the mold are constituted by hardened inserts. Preferably, the hardened inserts have a Rockwell hardness in the range from 50 to 62 HRC. The hardness is thus within the region of customary bending and punching tools. See: htttps://de.wikipedia.org/wiki/Rockwell_(Einheit);
aV. The injection mold or compression mold has to offer clear space around the hollow profile between its contact faces outside the injection molding or compression cavities. This clear space is preferably in the range from 1.0 to 10.0 mm.

The injection mold or compression mold additionally has to be such that it has been provided with at least two slide gates or at least two core pullers. These slide gates or core pullers are arranged in such a way that the two open ends of the inserted hollow profile can be closed by the travel of these at least two slide gates or at least two core pullers, or the closure elements that have been provided in process step c) and introduced into the open ends in process step d) can be blocked from being pushed away from the open ends of the hollow profile by the application of plastic to be applied in process step i).

At least one of the two slide gates or core pullers has to be such that it has an opening through which the closed interior of the hollow profile can be filled with a fluid, vented and emptied.

The at least two slide gates or core pullers have to be such that they reliably seal the two open ends of the hollow profile.

In one embodiment, the at least two slide gates or core pullers are such that they are constituted by hardened inserts in the injection mold or compression mold. Preferably, these hardened inserts have a Rockwell hardness in the range from 50 to 62 HRC.

Process Step b)

In process step b), at least one hollow profile with a ratio of diameter to wall thickness in the range from 5:1 to 300:1, preferably in the range from 10:1 to 200:1, more preferably in the range from 10:1 to 100:1, is provided, the outer hollow profile dimension C of which is greater by a range of 0.1% to 5% than the mold dimension A of the injection mold or compression mold cavity, and the outer hollow profile dimension D of which is smaller by a range of 0.1% to 5% than the mold dimension B of the at least one injection mold or compression mold cavity, and the hollow profile circumference UH of which corresponds to the cavity circumference UW of the at least one injection mold or compression mold cavity specified in process step a). According to the invention, the figures for the outer hollow profile dimensions C and D of the hollow profile to be provided in process step b) are based on 90° viewed in the direction toward the longitudinal axis of the hollow profile, and the figure for UH is based on the region of outer hollow profile dimension C and D. According to the invention, therefore, “thin-walled” in the context of the present invention means a ratio of diameter of a hollow profile for use in accordance with the invention to the wall thickness thereof in the range from 5:1 to 300:1.

A hollow profile for use in accordance with the invention can be produced by various methods, have various cross-sectional shapes and consist of various metals. Preferably, it is produced using at least one of the techniques of strand pressing, strand drawing, extrusion, blow molding, injection molding, seamless drawing, longitudinal welding, spiral welding, winding and pultrusion. A thin-walled hollow profile for use in accordance with the invention may have a circular, elliptical or polygonal—triangular, quadrangular, pentangular etc. up to and including a polyangular—cross section.

Preferably, a hollow profile to be provided in process step b) has a wall thickness in the range from 0.1 to 10.0 mm. A hollow profile for use in accordance with the invention preferably has at least two openings, one at each end.

Hollow profiles for use in accordance with the invention have been manufactured from a metal, where metal also includes alloys.

Preferred metals for production of hollow profiles for use in accordance with the invention are steel, aluminum, magnesium, copper, titanium, tin, zinc, lead, silver, gold or alloys thereof, especially steel, AlMgSi_{0.5} or brass.

Particular preference is given to using hollow profiles made of aluminum or steel, especially alloys of these two materials. The person skilled in the art is aware of such alloys from the production of semifinished products. In the case of aluminum alloys, the person skilled in the art is aware that magnesium increases strength but simultaneously significantly reduces formability, whereas silicon here has only minor effects. These two properties are affected only moderately by manganese and only slightly by zinc. Copper significantly increases strength and is favorable for ductility. (See: W. Hartmann & Co. (GmbH & Co.KG), 2018: produktinfos/ff2/index_ger.html). In the case of aluminum alloys or magnesium alloys, reference is additionally made to D. Altenpohl, Aluminium and Aluminiumlegierungen [Aluminum and Aluminum Alloys], Springer Verlag Berlin Heidelberg, 1965. With regard to steel alloys, reference is made to DIN EN 10020, DIN EN 10208, DIN EN 10216, DIN EN 10217 and DIN EN 10130.

Typical processes for production of semifinished hollow profiles are known to those skilled in the art as strand pressing, rolling and roll forming.

Preferably, hollow profiles for use in accordance with the invention or the metals or alloys for use therein have an elongation at break greater than 3%. Elongation at break A {\displaystyle A} is an index in material sciences that states the remaining extension of the tensile sample after fracture, based on the starting measurement length. It characterizes the deformation capacity or ductility of a material and can be defined differently in accordance with the characteristic mechanical properties of the types of material and also identified by different symbols. Elongation at break is the remaining change in length Δ L {\displaystyle \Delta L} after fracture, based on the starting measurement length L 0 {\displaystyle L_{0}} of a sample in the tensile test. The starting measurement length L 0 {\displaystyle L_{0}} is fixed prior to the tensile test by measurement marks on the tensile sample. See: htttps://de.wikipedia.org/wiki/Bruchdehnung.

If other production processes than the aforementioned hollow profile production processes are employed for the purpose of minimization of manufacturing tolerances, it is also possible to employ materials of less than 3% elongation at break.

Preference is given in accordance with the invention to using round metal tubes, rectangular metal tubes or square metal tubes as hollow profile. Tubes of this kind are supplied, for example, by Mifa Aluminium B.V., Rijnaakkade 6, 5928 PT Venlo, the Netherlands.

Process Step c)

Process step c) relates to the providing of at least two closure elements. Preferred closure elements are closure stoppers or closure caps. While closure stoppers are introduced to a certain degree into the hollow profile, closure caps are pulled over the open ends of the hollow profile. A prerequisite for the use of closure caps is that these correspond in a congruent manner to the outer dimension or outer cross-sectional shape of the hollow profile. Preferably, process step c) is effected with the proviso that the circumference of the hollow profile need not undergo any widening in order to accept the closure elements, which should be taken into account particularly in the case of use of closure stoppers.

“Congruent” in process step c) means that the shape and dimensions of the face of a closure cap that adjoins the hollow profile on the inside corresponds as far as possible to the shape and dimensions of the outwardly directed face of a hollow profile for use in accordance with the invention. This results in optimal sealing of the fluid for the remainder of the process. “Congruent” in the case of a closure stopper means that it adapts to the inwardly directed face or to the inner circumference of the hollow profile for use in accordance with the invention in order to seal it against escape of the fluid for use in process step e).

A closure element for use in accordance with the invention can be produced by various methods, have various cross-sectional shapes and consist of various materials. Preferably, it is produced using at least one of the techniques of turning, milling, casting, injection molding, pressing. A closure element for use in accordance with the invention may have a circular, elliptical or polygonal—triangular, quadrangular, pentangular etc. up to and including a polyangular—cross section. The cross-sectional shape of a closure element to be used will be chosen by the person skilled in the art in accordance with the hollow profile cross section to be provided in process step b). The person skilled in the art will therefore likewise use round closure elements on preferably round hollow profile cross sections resulting from tubular hollow profiles, and not triangular, quadrangular or differently shaped closure elements. The person skilled in the art will likewise also be guided by the hollow profile cross section in the case of the dimension of a closure element, it being necessary in each case to ensure sealing of the hollow profile against escape of the fluid.

Closure elements for use in accordance with the invention are preferably manufactured from metal or plastic, where the term “metal” in accordance with the invention also includes alloys. Preferred metals are steel, aluminum, magnesium, copper, titanium, tin, zinc, lead, silver, gold or alloys thereof, especially steel or brass.

Alternatively, closure elements for use in accordance with the invention have been manufactured from a plastic, preferably a thermoplastic or thermoset. The thermoplastic used is more preferably a polyamide or a polyester. The polyamide used is preferably a nylon-6. The polyester used is preferably a polyalkylene terephthalate, more preferably polybutylene terephthalate.

Most preferably, a closure element to be provided in process step c) is produced from a thermoplastic with at least one filler or reinforcer. Preference is given to using glass fibers as filler or reinforcer. Especially preferably, 0.1 to 85 parts by mass of filler or reinforcer are used per 100 parts by mass of the thermoplastic.

Especially preferably, a closure element to be provided in process step c) which is made of a glass fiber-reinforced nylon-6 with 15 to 60 parts by mass of glass fibers per 100 parts by mass of polyamide is used.

Closure elements to be used in accordance with the invention that are based on thermoplastics are produced in a step preceding the process according to the invention by injection molding, turning, milling or pressing.

In the design, the material and other configuration features of the closure elements to be provided in process step c), the person skilled in the art will be guided by the functions of a closure element:
1. Closure elements to be used must seal the hollow profile wall against escape of liquid;
2. Closure elements to be used are supported by slide gates or core pullers on the mold side and locking of these slide gates or core pullers to counter the forces that can occur as a result of the injection molding or compression pressure of the plastic component to be applied or else in the closure operation of the injection mold or compression mold.

Preferably, closure elements to be used in accordance with the invention are used together with at least one seal in each case. In the case of preferably round closure elements in the case of tubular hollow profiles, a closure element with at least one seal in the form of an 0-ring is used.

According to htttps://de.wikipedia.org/wiki/O-Ring, O-rings are annular sealing elements. The name derives from the round (0-shaped) cross section of a ring. O-rings are standardized according to ISO 3601, where the size of O-rings is reported as internal diameter • cord diameter. O-rings are encountered in virtually every field of industry. Usually, an O-ring is present in static seals. A distinction should be made here between radial-static and axial-static sealing. The former includes employment in the case of cylinders or tubes, and axial-static sealing that in the case of flanges, plates and closures. Preferably, seals to be used in accordance with the invention, especially O-rings, are manufactured from nitrile rubber (acrylonitrile-butadiene rubber (NBR)), the standard material for hydraulic and pneumatic applications.

Preferably, at least one closure element has a device for introducing the fluid into the hollow profile or for emptying the fluid from the hollow profile, especially when the fluid is supplied to or removed from the hollow profile within the injection mold or compression mold. Preferred devices are quick couplings with automatic valves that permit rapid and leak-free filling and emptying, and also deaeration of incompressible hydraulic fluids. Quick couplings of this kind are known to the person skilled in the art from htttps://de.wikipedia.org/wiki/Schlauchkupplung. For flexible and hence economically viable utilization, conduits are often not bonded to one another in a fixed manner but configured so as to be separable by means of such quick couplings or hose couplings. They enable rational and reliable connection and switching of systems, aggregates, items of equipment etc. The design of the quick couplings or hose couplings is dependent on the end use, the medium to be conveyed (air, gases, water, oil, acid etc.) and the pressure conditions (vacuum or elevated pressure) within or outside the media-containing components.

Quick couplings or hose couplings for use with preference in accordance with the invention are hydraulic couplings as used for hydraulic equipment or for rapid changing of tools. In the case of use of water as fluid of the invention or of a water-based fluid, water hose couplings are used, as known to the person skilled in the art for industry, horticulture and landscaping, and in the domestic sector.

Process Step d)

In process step d), the two open ends of the hollow profile are sealed by means of the closure elements provided in c). Preferably, for this purpose, closure elements that are pushed or pressed into the open ends as stoppers with minimum expenditure of force in axial direction of the hollow profile, or pushed, pulled or pressed as caps over the open ends of the hollow profile, are used. Preferably, these closure elements have radial seals, especially seals in the form of O-rings. The radial frictional forces of the closure elements and seals are such that the closure elements, after being introduced or pushed across, remain in their position and permit filling and deaerating of the resultant cavity without changing position.

Preferably in accordance with the invention, the sealing is effected outside the injection mold or compression mold, i.e. prior to the insertion of the hollow profile into the injection mold or compression mold.

Alternatively, the sealing can also be effected within the injection mold or compression mold. Preferably, this operation is effected in a fully automatic manner by means of two mold slide gates or mold core pullers which, after the insertion of the hollow profile and after the closure of the mold, move into the open ends of the hollow profile together with the closure elements that are preferably part of the slide gates or core pullers and seal them such that the interior of the hollow profile can be filled, vented and emptied again after process step i). For this purpose, the slide gates or core pullers, analogously to the closure elements, have a device for filling or emptying of the fluid and for deaerating of the hollow profile.

Preferably, the hollow profile is sealed by the closure elements and the slide gates or core pullers of the injection mold or compression mold against internal pressures in the range from 1 to 1000 bar that can occur by the action of the fluid on the inner wall of the hollow profile during process step i) and/or process step h).

The way in which core pullers or slide gates work in an injection mold is known to those skilled in the art. Descriptions or elucidations can be found in Plast-Spritzer.de, info@plast-spritzer.de, C. Gottesleben, Hermannsburg, 2015 or in htttps://de.wikipedia.org/wiki/Spritzgie % C3%9Fmaschine. Preferably, slide gates or core pullers for use in accordance with the invention are manufactured from the tool steels that are customary in injection mold and compression mold construction and hardened. Preference is given to using hardened slide gates or core pullers having a Rockwell hardness in the range from 50 to 62 HRC.

Process Step e)

In process step e), the fluid is introduced into the sealed hollow profile through at least one of the closure elements.

If process step d) is conducted within the injection mold or compression mold, the fluid is supplied to the hollow profile in process step e) through at least one of the closure elements likewise within the injection mold or compression mold.

Preferably, fluids used are incompressible hydraulic fluids. By contrast with compressible fluids, an incompressible fluid is a liquid having a density that does not depend on the pressure.

Conversely, this means that fluids having a density that alters, for example, as a result of thermal effects can be incompressible. Since these effects in practice are usually considerably smaller than changes in density owing to changes in pressure, a fluid, in accordance with the invention, is considered to be incompressible when the density is constant along any trajectory. However, constant density is not a criterion for incompressibility.

Incompressible fluids do not exist in reality; they are instead an idealization that considerably simplifies many calculations with negligible error, for example water in water conduits under standard conditions. In particular applications of hydraulics or fluid technology, however, the low compressibility of a hydraulic liquid absolutely has to be taken into account.

The incompressibility of a fluid is equivalent to the disappearance of compressibility [symbol] , κ {\displaystyle \kappa}, which is defined as the relative change in volume with changing pressure and a constant temperature:

$$κ = 0 \\ ⇔ - \frac{1}{V} {( \frac{\partial V}{\partial p} )}_{T} = 0 \\ ⇔ {( \frac{\partial V}{\partial p} )}_{T} = 0$$

This formulation derives from a continuity equation as the freedom of the flow from divergence, neglecting any temperature dependence:

\vec{∇}·\vec{v}=0⇔ div \vec{v}=0

The underlying mathematical model is the Navier-Stokes equations. See: htttps://de.wikipedia.org/wiki/Inkompressibles_Fluid.

A “hydraulic” fluid is one required for transfer of energy (volume flow, pressure) in hydraulic systems in fluid technology.

htttps://de.wikipedia.org/wiki/Hydraulikfl%C3%BCssigkeit distinguishes between:
hydraulic fluids based on mineral oils,
hydraulic fluids for the foods and animal feeds industry,
rapidly biodegradable hydraulic fluids,
comparatively non-flammable liquids, and
water.

Among these, preference is given in accordance with the invention to the comparatively non-flammable fluids and water that are to be used with preference in industrial production operations. Comparatively non-flammable fluids that are preferred in accordance with the invention are

HFA: oil-in-water emulsions or solution products with a water content of more than 80%, or concentrates based on mineral oil or based on soluble polyglycols;

HFB: water-in-oil emulsions having a water content of more than 40% or mineral oil;

HFC: water glycols having a water content of more than 35% or polyglycol solution;

HFD: anhydrous synthetic liquids having a higher density than mineral oil or water.

The hollow profile interior is preferably deaerated by filling it with a fluid, preferably up to 100% of the volume of the interior, until no more air remains in the interior. Preferred devices are fully automatic systems for filling and emptying, and for deaeration of fluids, preferably incompressible hydraulic fluids. The person skilled in the art is aware of such devices, for example for filling or emptying of hydraulic systems; in this regard see also DE 202008003682 U1.

Process Step f)

As well as the configuration of the metal-based hollow profile to be provided in process step b), the configuration of the injection mold or compression mold to be provided in process step a) is likewise important in order that the process according to the invention, especially the insertion and sealing of the injection molding or compression molding cavity, works without difficulty.

The hollow profile is inserted here into the at least one cavity without extension of the hollow profile. The join between hollow profile and the cavity of the injection mold or compression mold that adjoins the hollow profile section to be provided with application of plastic is sealed solely via change in shape of the circumference of the hollow profile on closure of the injection mold or compression mold, while the hollow profile circumference UH itself remains the same.

In the case of the preferred use of hollow profiles with a round circumference, where the hollow profile has the shape of a tube, there is a change in shape preferably to an ellipse. In the case of use of hollow profiles with elliptical circumference, there is preferably a change in shape to a round circumference.

Preferably, the ratio of the hollow profile circumference UH to the inner cavity circumference UW of the at least one mold cavity of the mold is 1:1. It is extremely surprising to the person skilled in the art that solely the closing motion of the injection mold or compression mold and the resulting change in shape of the hollow profile with respect to the inner circumference of the mold cavity UW reliably seals the gap or join and hence seals it for the injection molding or compression operation, and, even in the case of a tolerance-related oversize of the hollow profile circumference UH by up to +5%, excess material for the hollow profile wall is not injected into the separation planes of the injection mold or compression mold. This ensures that there can be no damage to the mold, especially damage to the separation planes, nor damage to the hollow profile itself. This property of the process according to the invention, the change in shape of the hollow profile with the closure of the injection mold or compression mold and hence simultaneously the sealing of the mold cavity with respect to the outer hollow profile surface, allows the subsequent and locally restricted application of plastic to the metal-based hollow profile in process step e) without auxiliaries positioned within the hollow profile that counteract the injection or compression pressure and hence, by comparison with the prior art, without additional process steps and with distinctly shortened cycle times.

Preferably, an injection mold or compression mold for use in accordance with the invention and also a metal-based hollow profile for use in accordance with the invention have the following features in order that the latter with all its dimensional and shape tolerances can be inserted without force into the mold provided in process step a):
fI. The injection mold or compression mold has to be such that it seals the injection molding or compression cavities with respect to the regions of the hollow profile in which there is no application of plastic in process step e) on closure of the mold. For this purpose, the injection mold or compression mold needs, at the axial ends of the at least one injection molding or compression cavity, contact faces in the mold that compress the hollow profile during the closure of the mold from the outer hollow profile dimension C to the mold dimension A, which simultaneously alters the outer hollow profile dimension D to the mold dimension B, but the circumference UH of the hollow profile remains identical to the circumference UW of the at least one injection mold or compression mold cavity;
fII. In one embodiment, the contact faces of the at least two mold halves with respect to the hollow profile in the injection mold or compression mold are executed such that a greater circumference UH of the hollow profile by +5% over and above the compression described in fI. is additionally pressed onto the same circumference UW of the injection molding or compression molding cavity described in fI.;
fIII. The contact faces of the at least two mold halves in the injection mold or compression mold that have been mentioned in fI. and fII., with the mold closed, enclose the hollow profile over its entire extent and preferably have a width, i.e. an extent viewed in the axial direction of the hollow profile, in the range from 1.0 to 50.0 mm, preferably 3.0 to 25.0 mm, more preferably 5.0 to 10.0 mm;
fIV. In one embodiment, the contact faces of the at least two mold halves with respect to the hollow profile in the injection mold or compression mold are executed such that these regions in the mold are constituted by hardened inserts. These hardened inserts preferably have a Rockwell hardness in the range from 50 to 62 HRC. The hardness is thus within the region of customary bending and punching tools. See: htttps://de.wikipedia.org/wiki/Rockwell_(Einheit);
fV. Preferably, the injection mold or compression mold offers clear space around the hollow profile between its contact faces outside the injection molding or compression cavities. This clear space is preferably in the range from 1.0 to 10.0 mm.

Process Step g)

In process step g), the at least two closure elements that close the two open ends of the metal-based hollow profile are supported by means of the slide gates or core pullers on the mold side. These slide gates are positioned within the injection mold or compression mold such that, after insertion of the hollow profile and closure of the injection mold or compression mold, they face the open ends of the hollow profile and in so doing support the closure elements used on the outside in one version of the process in process step d), or else—as described in the alternative—they apply the closure elements to the open ends of the hollow profile, or insert them into the open ends of the hollow profile and hence close and seal the hollow profile. For this purpose, the slide gates or core pullers, after process step h), are locked by the mechanisms customary in injection mold or compression mold construction, such that pressures in the range from 1 to 1000 bar can act on the inner wall of the hollow profile during the process. Locking mechanisms that are to be employed correspondingly are known to the person skilled in the art from injection molding machine and injection mold construction. See: Euro-Mold Special, Technischer Fachverlag Möller e.K., Velbert, 1.12.-4.12.2010.

Process Step h)

In process step d), the at least one cavity of the injection mold or compression mold is closed and the hollow profile is compressed by the mold closure movement in the closure direction of the at least one cavity, with a change in shape of the hollow profile provided in b) to the effect that the outer surface of the hollow profile, after the end of the closure operation, corresponds to the inner shape of the cavity of the mold provided in process step a) in the region of the contact surfaces at the axial ends of the at least one injection mold or compression mold cavity. The closure of the at least one cavity makes the outer dimension C identical to the mold dimension A and the outer dimension D identical to the mold dimension B. The hollow profile circumference UH still corresponds to the cavity circumference UW of the injection mold or compression mold cavity.

By means of the contact surfaces described in process step c) in the injection mold or compression mold, the hollow profile in process step d) is clearly kept within the at least one cavity and the cavities in the hollow profile that are provided for the injection molding or for the compression are sealed.

The closing of the injection mold or compression mold requires a closure force that compresses the hollow profile to a new shape defined by the configuration of the cavity of the injection mold and compression mold and seals the at least one cavity. The level of the closure force to be expended is guided firstly by the shape of the metal-based hollow profile provided in process step b). Moreover, the shape, dimensions, wall thickness and material properties of the metal-based hollow profile are crucial for the pre-calculation of the closure force that has to be taken into account by the person skilled in the art in the design of the process according to the invention.

The compression force to be expended for the compression of the hollow profile in process step h) is preferably below the closure force of the injection mold in the case that an injection molding process is employed for the application of plastic.

In the case of application of plastic by compression molding, the pressing force to be employed for the compression of the hollow profile in process step h) is in the region of the closure force of the compression mold to be used for this purpose +/−10%.

The level of the closure force of the injection mold or compression mold is secondly also guided by the projected area for the application of plastic in process step e) and, in the case of use of injection molding, the injection pressures that are required to apply the corresponding plastics in process step i).

Preferably in accordance with the invention, the compression in process step h) is effected until:

Outer hollow profile dimension C=mold dimension A and

Outer dimension D=mold dimension B and

Hollow profile circumference UH=mold cavity circumference UW.

In this case, the cavity has been sealed over its circumference with respect to the hollow profile and the mold has been stressed to the least degree at its contact surfaces.

If it is the case that the outer hollow profile dimension C or D or the hollow profile circumference UH is too small and the deformation by the mold is insufficient to achieve outer hollow profile dimension D=mold dimension B, this would leave a gap. In this case, the tolerances of the hollow profile have to be chosen such that this case does not occur.

If the outer hollow profile dimension A or the hollow profile circumference UH chosen is too large, the outer hollow profile dimension D reaches the mold dimension B before the injection mold or compression mold is completely closed, which leads to tangential compression of the hollow profile wall. In this case too, therefore, the tolerances of the hollow profile should be chosen such that compression occurs up to a maximum of compressive expansion of the material, but there is no occurrence of escape of the hollow profile wall into cavities between the separation surfaces of the injection mold or compression mold. In this case, the cavity has likewise been sealed over its circumference with respect to the hollow profile but the mold has been subjected to relatively high stress at the contact surfaces.

Process Step i)

In process step i), the slide gates or core pullers are locked and hence the at least two closure elements provided in process step c) are simultaneously blocked from being pushed away from the open ends of the hollow profile by the application of plastic described in process step j).

Process Step j)

In process step j), plastic is applied, preferably in the form of a melt, to the outer wall of the hollow profile. The level of the injection pressures and hold pressures that is to be employed in process step j), the injection rates, the changeover times between injection and maintaining hold pressure, the hold pressure times, the melt and mold temperatures and the residual mass cushion of the plastic applied are additionally dependent on the plastic materials to be used, the geometry of the cavity/cavities to be filled with plastic, the position of the application, the sprue in the case of injection molding, and the durability of the hollow profile provided in process step b) and inserted in process step f), which has to be taken into account in advance by the person skilled in the art in the design of the process of the invention.

The compression of the hollow profile in process step h), especially by means of the mold contact surfaces described in process step h), achieves sealing of the injection mold or compression mold to counter escape of the plastic to be applied in process step e) between regions of the hollow profile with applied plastic and without applied plastic within the injection mold or compression mold cavity. In one embodiment, the tool contact surfaces are executed in such a way that these regions in the mold are constituted by hardened inserts.

The execution of hardened mold inserts described in process step f) under point fIV. serves, in process step h) and in process step j), to reduce the wear on the mold contact surfaces since these are the only contact sites between injection mold or compression mold and hollow profile and the hardened mold inserts preferably have distinctly higher hardness than the material of the hollow profile.

The application of plastic to the at least one hollow profile in process step j) is preferably effected by injection molding or compression molding, especially injection molding.

Application of Plastic by Injection Molding

According to DIN 8580, manufacturing processes for production of geometric solid bodies are divided into six main groups. Injection molding is assigned to main group 2, primary forming. It is especially suitable for mass-produced articles. Reworking in the case of injection molding is minor or can be dispensed with entirely, and even complicated shapes and outlines can be manufactured in one operation. Injection molding as a manufacturing method in plastics processing is known in principle to those skilled in the art;

See: htttps://de.wikipedia.org/wiki/Spritzgie%C3%9Fen.

In injection molding, an injection molding machine is used to liquefy or plastify the plastic to be processed and inject it into a mold, the injection mold, under pressure. In the mold, the plastic is converted back to the solid state as a result of cooling or as a result of crosslinking reaction and, after the opening of the mold, is removed as a finished part. It is the cavity of a mold that determines the shape and surface structure of the solidified applied plastic in the final product, in the plastic-metal composite component in the present invention. Nowadays, products in the weight range from a few tenths of a gram up to an order of magnitude of 150 kg are producible by injection molding.

Injection molding permits a virtually free choice of shape and surface structure, in particular smooth surfaces, grains for touch-friendly regions, patterns, engravings and color effects. Together with economic viability, this makes injection molding the most commonly used process for mass production of plastic parts in virtually all sectors.

An injection molding apparatus comprises at least the following components: 1. screw 2. intake funnel 3. pellets 4. plastifying barrel 5. heating elements 6. mold.

The following steps are effected within an injection molding apparatus: 1. plastifying and metering, 2. injecting, 3. maintaining hold pressure and cooling, and 4. demolding.

1. Plastifying and Metering
The thermoplastic trickles into the flights of a rotating screw in the form of a granular material. The granular material is conveyed in the direction of the screw tip and is heated and melted by the heat of the barrel and the heat of friction that arises in the division and shearing of the material. The melt collects in front of the screw tip since the exit nozzle is closed at first. Since the screw is axially movable, it retracts as a result of the pressure and screws out of the material like a corkscrew. The backward motion is attenuated by a hydraulic cylinder or by electrical means, such that a backpressure builds up in the melt. This backpressure in conjunction with the screw rotation compresses and homogenizes the plastic to be injected as injection molding material.
The screw position is measured and, as soon as an amount of injection molding material sufficient for the workpiece volume has collected, the metering operation is ended and the screw rotation is stopped. The stress on the screw is likewise actively or passively released, such that the melt is decompressed.

2. Injecting
In the injection phase, the injection unit is moved to the closure unit, the exit nozzle is pressed against it and the screw is put under pressure on the reverse side. This forces the melt under high pressure, preferably at a pressure in the range from 500 to 2000 bar, through the opened exit nozzle and the gate or gate system of the injection mold into the shaping cavity. A nonreturn barrier prevents backflow of the melt in the intake funnel direction.
During the injection, an attempt is made to achieve very substantially laminar flow characteristics of the melt. This means that the melt is immediately cooled in the injection mold where it touches the cooled mold wall and “sticks” in solidified form. The subsequent melt is forced through the resultant narrowing melt channel at even higher velocity and with even more shear deformation and is subjected to expansive deformation at the melt front toward the edge. Removal of heat via the mold wall occurs concurrently with supply of heat through shear heating. The high injection rate produces a shear velocity in the melt that allows the melt to flow more easily. Rapid injection is not the aim since high shear velocities can cause increased molecular degradation within the plastic. The surface of the product to be produced by injection molding, the appearance thereof and ultimately the state of orientation of the plastic molecules are also affected by the injection phase.

3. Maintaining hold pressure and cooling
Since the mold is colder than the plastic material, the mold preferably having a temperature in the range from 20 to 120° C. and the plastic material preferably having a temperature in the range from 200 to 300° C., the melt cools down in the mold and solidifies on attainment of the solidification point of the particular plastic used, preferably of the thermoplastic or thermoplastic-based compound.
Compounding is a term from the plastics industry, synonymous with plastics processing, that describes the process of upgrading plastics by mixing in admixtures (fillers, additives etc.) for specific optimization of the profiles of properties. Compounding is preferably effected in extruders and comprises the process operations of conveying, melting, dispersing, mixing, degassing and pressure buildup. See: htttps://de.wikipedia.org/wiki/Compoundierung. A compound therefore refers to a thermoplastic or thermoset with added fillers or additives.
The cooling on attainment of the solidification point of the particular plastic used is associated with a volume shrinkage that has an adverse effect on trueness to scale and surface quality of the product to be manufactured, in the present invention the application of plastic that is to be manufactured in process step j) and bonded in a form-fitting manner to the outside of the hollow profile. In order to partly compensate for this shrinkage, even after the filling of the mold, a reduced pressure is maintained in order that further plastic material can flow in and compensate for the shrinkage. This hold pressure can be maintained until the sprue has solidified.
After the hold pressure phase has ended, the exit nozzle can be closed and the plastifying and metering operation for the next molding can already commence in the injection unit. The application of plastic in the mold cools down further in the residual cooling time until the center, the liquid core of the applied plastic, has solidified and achieved a stiffness sufficient for demolding. This operation is also referred to as solidification and, according to the invention, proceeds in process step k) for the application of plastic.
The injection unit can then be moved away from the closure unit since no plastic can escape from the sprue any longer. The purpose of this is to prevent transfer of heat from the warmer exit nozzle to the colder sprue.

4. Demolding
For demolding of an injection-molded product or of the hollow profile that has been endowed with applied plastic in the inventive process step l), the cavity is opened and the product is ejected by means of pins that penetrate into the cavity and either falls out (bulk material) or is removed from the injection mold by handling devices and laid down in an orderly manner or sent directly to further processing. Preferably, for this purpose, the injection mold or compression mold is provided with an ejector side.
The sprue either has to be removed by separate processing or is automatically severed in the demolding operation. Sprueless injection molding is also possible with hot runner systems in which the gate system remains constantly above the solidification temperature of the plastic to be used, preferably thermoplastic, thermoset or compound, and the material present can thus be used for the next shot.

Application of Plastic by Compression Molding

Compression molding belongs to the family of primary forming methods. Compression molding is a production method for plastics suitable for slightly curved or flat components. The main field of this method is the automotive industry, where it is used for production of relatively large components having two-dimensional or simple three-dimensional structure, especially engine hoods, shock absorbers, spoilers or tailgates. It is possible to process either thermoset or thermoplastic materials.

At the start of the compression molding process, the molding compound to be processed is introduced into the heated cavity provided. Then the cavity is closed using a pressure piston. As a result of the pressure, the molding compound takes on the shape defined by the mold. In the case of thermoset materials the temperature serves to affect the hardening operation, and in the case of thermoplastics to melt the plastic. After the cooling, the finished product can be removed from the mold and optionally processed further.

The compression molding method is particularly suitable for moderate numbers of items, since the mold costs in this case are generally lower than in the case of injection molding for example. Compression molding can also be used for production of fiber composite materials, including for production of fiber-reinforced plastics.

See: htttps://de.wikipedia.org/wiki/Formpressen

A known compression molding process for thermoplastics is, in particular, the D-LFT (direct long fiber thermoplastic molding) method as described, for example, in DE-A 43 30 860.

Known compression molding methods for thermosets are, in particular, the SMC (sheet molding compound) method and the BMC (bulk transfer molding compound) method. An SMC method is described, for example, in EP 1 386 721 A1. With regard to BMC methods see: Handbuch Spritzgießen [Injection molding Handbook], ISBN 978 3 446 15632 6, 1st edition 2001, pages 1022-1024, Carl Hanser Verlag.

Plastics to be Applied in Process Step j)

Plastics to be used in process step j) are preferably thermoplastics or thermosets, more preferably thermoplastics.

Preferred thermoplastics are polyamides (PA), polyesters, especially polybutylene terephthalate (PBT) or polyethylene terephthalate (PET), polyethylene (PE), polypropylene (PP) or polyvinyl chloride (PVC). The thermoplastic used in process step j) is more preferably polyamide or polyester. The polyamide used is preferably a nylon-6. In particular, the polyester used is PBT. Preferred thermosets are epoxy resins, crosslinkable polyurethanes or unsaturated polyester resins.

The thermoplastic or thermoset is preferably used in the form of a compound.

More preferably, the plastic to be applied in process step j) is produced from a thermoplastic with at least one filler or reinforcer. Preference is given to using at least one filler or reinforcer from the group of carbon fibers [CAS No. 7440-44-0], glass beads, solid or hollow glass beads, glass fibers, ground glass, in each case preferably composed of aluminum borosilicate glass having an alkali content of 1% (E glass) [CAS No. 65997-17-3], amorphous silica [CAS No. 7631-86-9], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0] and montmorillonite [CAS No. 67479-91-8]. Particular preference is given to using glass fibers.

Especially preferably, fillers or reinforcers are used in amounts in the range from 0.1 to 150 parts by mass per 100 parts by mass of the thermoplastic. Very especially preferably, fillers or reinforcers are used in amounts in the range from 15 to 150 parts by mass per 100 parts by mass of the thermoplastic.

Especially preferably, in process step j), an application of plastic composed of glass fiber-reinforced nylon-6 with 15 to 150 parts by mass of glass fibers per 100 parts by mass of polyamide is used in the injection molding process. Compounds of this kind are available under the Durethan® name from Lanxess Deutschland GmbH, Cologne.

A thermoset to be applied in process step j) also preferably contains at least one of the abovementioned fillers or reinforcers. Preferably, the thermoset comprises glass fibers or carbon fibers as filler or reinforcer. Especially preferably, 10 to 150 parts by mass of glass fibers or carbon fibers as filler or reinforcer are used per 100 parts by mass of the thermoset.

Process Step k)

In process step k), the plastic applied or overmolded plastic is cooled down, also referred to as solidification. The term “solidification” describes the hardening of the molten plastic applied in process step j) as a result of cooling or chemical crosslinking to give a solid body. In the case of simultaneous shaping, it is possible in this way to directly apply functional elements, structures and surfaces to the hollow profile.

In one embodiment of the present invention and in the case of a further above-described surface treatment, after the solidification of the plastics melt on the outer surface of the hollow profile, preferably a metal tube, the result is an application of plastic in the form of a continuous plastics ring having a structured inner surface that exactly constitutes the positive image of the surface structure of the outer wall of the hollow profile, preferably the metal tube.

An inventive shear-resistant, shear-stiff, highly durable and form-fitting bond around the outer wall of the hollow profile, preferably around the outer wall of the hollow profile in the form of a metal tube, is the result.

Further details of process step k) have already been described above in the “Maintaining hold pressure and cooling” section.

Process Step l)

In process step l), the finished composite part is removed from the injection mold or compression mold since, with solidification of the plastics melt, the pressure in the application of plastic is no longer present and the compression force or closure force has been dissipated with the opening of the mold. Further details have already been described above in the “Demolding” section.

Process Step m)

Finally, in process step m), the fluid is emptied out of the hollow profile. For this purpose, the quick couplings already described in process step c) with automatic valves that permit rapid and leak-free filling and emptying and deaeration of incompressible hydraulic fluids are preferably employed. Alternatively, the emptying of the fluid in the injection mold or compression mold takes place prior to process step l). In this case too, devices having automatic valves should preferably be used, which permit rapid and leak-free emptying of the fluid.

Finally, the removal of the at least two closure elements in reverse sequence to the introduction in process step d) takes place by means of an automatic device outside the injection mold or compression mold.

Alternatively, the at least two closure elements are removed within the injection mold or compression mold by withdrawal of the (mold) slide gates or core pullers described in process step d).

In an alternative or preferred embodiment, in process step m), the fluid is first emptied out of the hollow profile and the closure elements are then removed. However, this process variant is possible only with closure elements that have at least one device for filling/emptying as described in process step c).

Plastic-Metal Composite Component

Plastic-metal composite components to be produced in accordance with the invention are used in corresponding configuration preferably for motor vehicle construction, especially in automobile construction. These are preferably bodywork parts, especially a cross car beam (CCB). Cross car beams are known, for example, from U.S. Pat. No. 5,934,744 A or U.S. Pat. No. 8,534,739 B.

Likewise preferably, the plastic-metal composite component is a motor vehicle bodywork part, especially a front-end module carrier, also referred to as “Grill Opening Reinforcement” or as “Bolster”. Front-end module carriers are known, for example, from EP 0 519 776 A1.

In the plastic-metal composite component of the invention, also referred to as hybrid component owing to the two components, the hollow profile and the application of plastic applied in process step j) by means of a plastics melt reinforce and strengthen one another. Moreover, the application of plastic to the outer wall of the hollow profile applied in process step j) additionally serves for integration of function for the purposes of system or module formation for attachment of plastics structures or plastics surfaces.

Preferred embodiments of a plastic-metal composite component to be produced in accordance with the invention may have beads or similar deformations and/or bores or similar openings that are preferably to be added subsequently in the hollow profile.

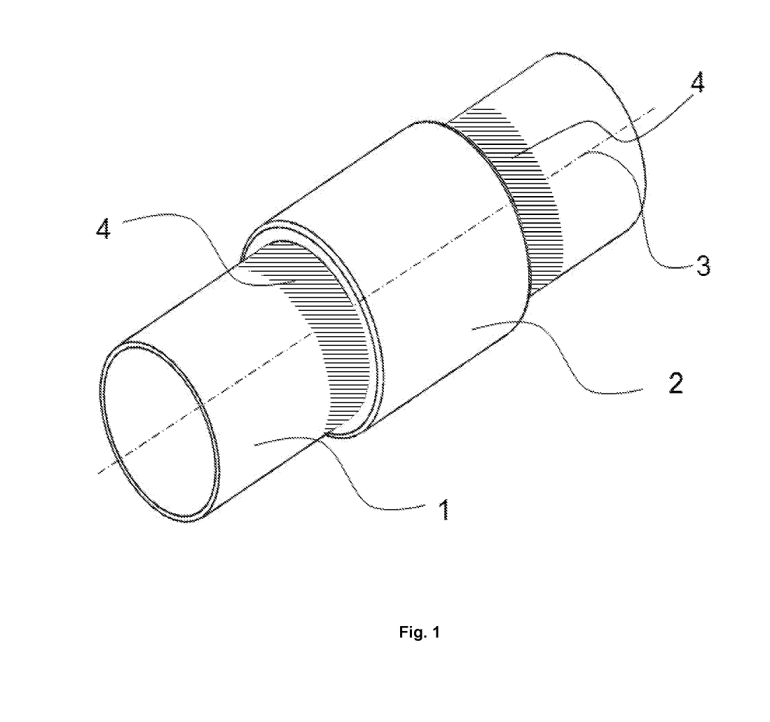

The present invention is elucidated by FIG. 1 to FIG. 6:

FIG. 1 shows a plastic-metal composite component to be produced in accordance with the invention by the injection molding or compression method, in which 1 represents the hollow profile, here in the embodiment of a tube with elliptical cross section, and 2 represents an application of plastic bonded to the hollow profile in a form-fitting or adhesive manner. 3 shows the longitudinal axis of the hollow profile. 4 shows the contact surfaces for sealing that are present alongside the application of plastic 2 on the hollow profile, in the range of 1.0-10.0 mm, viewed in the direction of longitudinal axis 3.

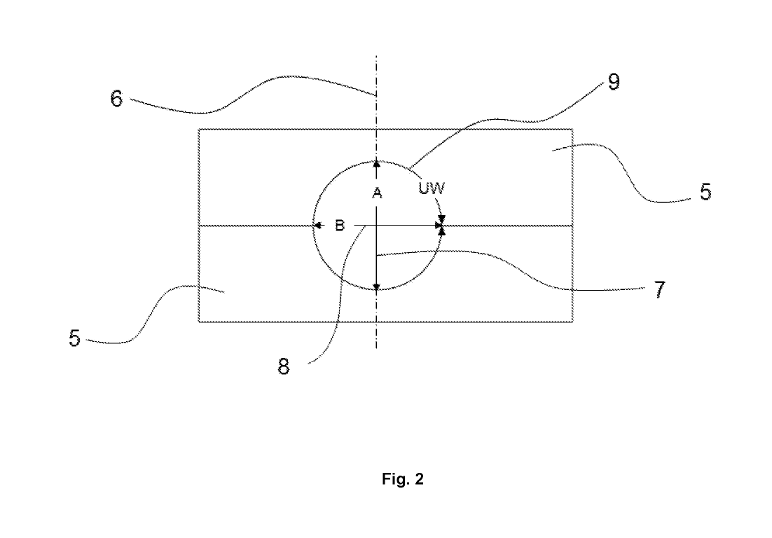

FIG. 2 shows the cross section of an injection mold or compression mold 5 to be used in accordance with the invention in the closed state with the opening and closing direction 6 in the region of the contact surfaces to the seal 4 present alongside the application of plastic 2 on the hollow profile, in the range of 1.0-10.0 mm, viewed in the direction of the longitudinal axis of the hollow profile 3. 7 shows the mold dimension A of the mold cavity viewed in closure direction. 8 shows the mold dimension B of the mold cavity viewed at right angles to closure direction, and 9 the cavity circumference UW of the injection mold or compression mold cavity in the region of mold dimensions A and B.

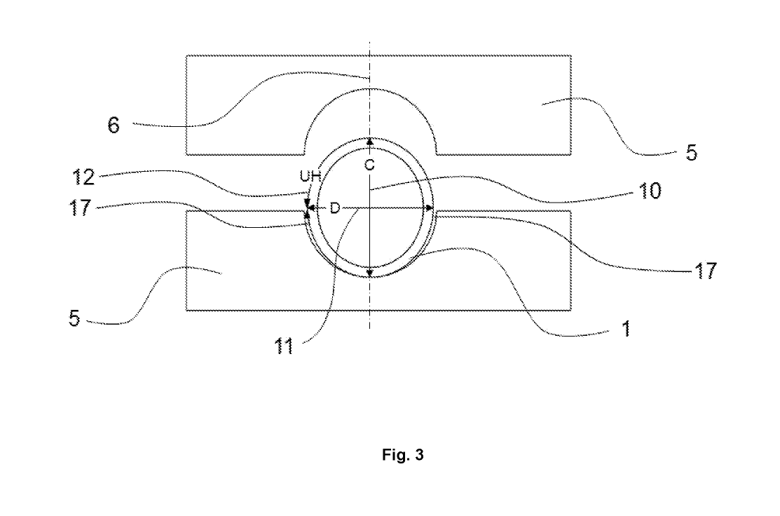

FIG. 3 shows the cross section of an injection mold or compression mold 5 in the open state with the hollow profile 1 inserted in the region of the contact surfaces to the seal 4 present alongside the application of plastic 2 on the hollow profile 1, in the range of 1.0-10.0 mm, viewed in the direction of the longitudinal axis of the hollow profile 3 (see FIG. 1). 10 shows the outer dimension C of the hollow profile 1 viewed in the closure direction. 11 shows the outer dimension D of the hollow profile 1, and 12 shows the hollow profile circumference UH of the hollow profile 1 in the region of the hollow profile dimensions C and D. 17 shows the play between hollow profile and mold cavity.

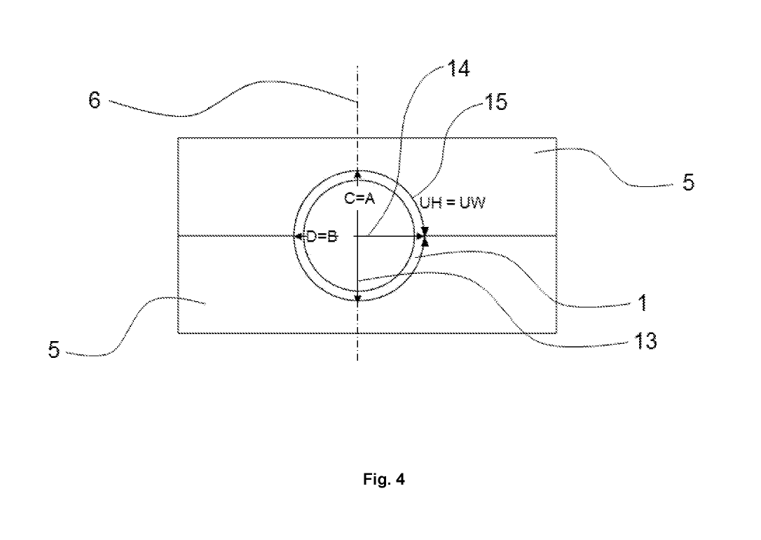

FIG. 4 shows the cross section of an injection mold or compression mold 5 to be used in accordance with the invention in the closed state with the hollow profile 1 inserted in the region of the contact surfaces to the seal 4 present alongside the application of plastic 2 on the hollow profile 1, in the range of 1.0-10.0 mm, viewed in the direction of the longitudinal axis 3 (see FIG. 1). 13 represents the outer dimension C of the compressed hollow profile 1 in the region of the contact surfaces to the seal 4, present alongside the application of plastic 2 on the hollow profile 1, in the range of 1.0-10.0 mm, viewed in the direction of the longitudinal axis 3 thereof. After the compression in process step h), the outer dimension C is equal to the mold dimension A. 14 represents the outer dimension D of the compressed hollow profile 1 in the region of the contact surfaces to the seal 4, present alongside the application of plastic 2 on the hollow profile 1, in the range of 1.0-10.0 mm, viewed in the direction of the longitudinal axis 3 thereof. After the compression in process step h), the outer dimension B is equal to the mold dimension D. 15 represents the hollow profile circumference UH of the compressed hollow profile 1 in the region of the contact surfaces to the seal.

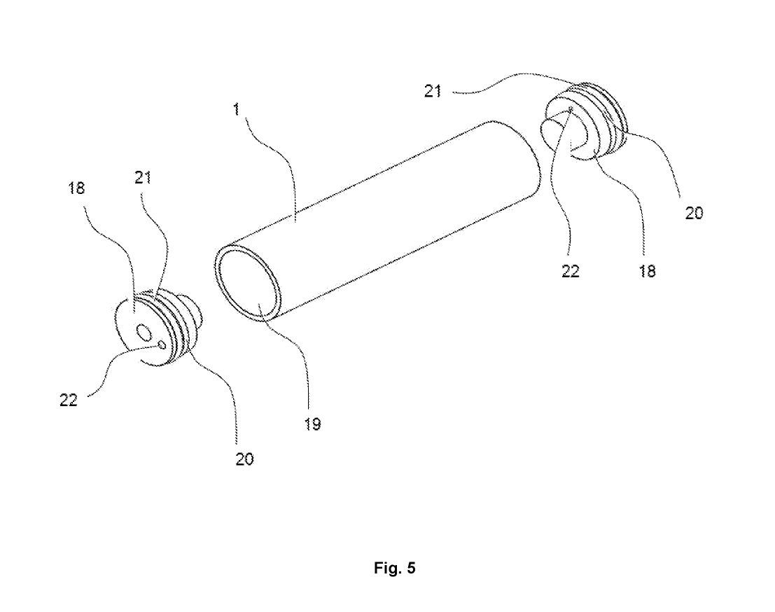

FIG. 5 shows a hollow profile 1 to be provided in accordance with the invention, with closure elements to be provided in accordance with the invention, here in the form of closure stoppers 18, with hollow profile inner surface 19 and the congruent sealing surfaces 20 and the at least one O-ring seal 21 and the openings 22 described in process step c) for filling, emptying and deaerating the hollow profile interior with a fluid.

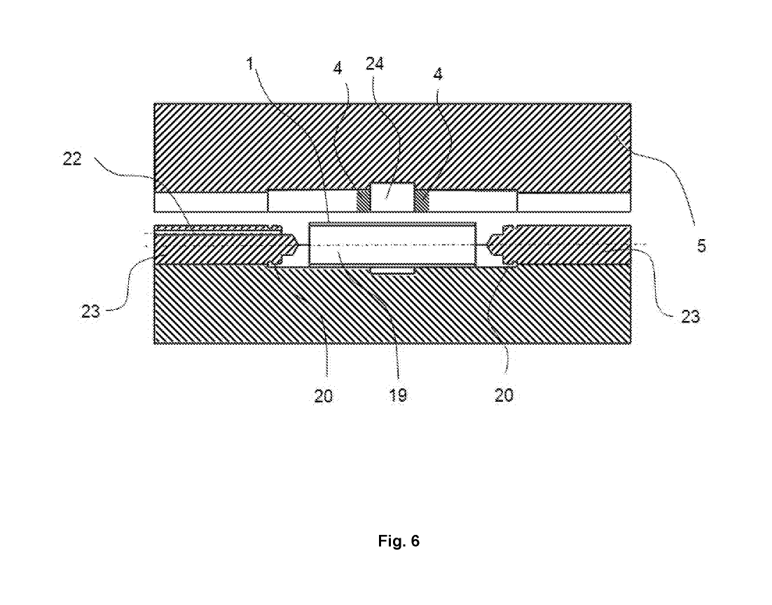

FIG. 6 shows the cross section of an open injection mold or compression mold 5 in the open state with the hollow profile 1 inserted, with the hollow profile inner surface 19, in longitudinal section, in the middle of the cavity for the accommodation of the hollow profile 1, represented by the slide gates or core pullers 23 described in process step a) and the openings 22 for filling, emptying and deaerating the hollow profile interior with a fluid, and the contact surfaces 4 for sealing of the plastic applied at the side of the cavity 24 in which the plastic is applied.

It will be understood that the specification and examples are illustrative but not limitative of the present invention and that other embodiments within the spirit and scope of the invention will suggest themselves to those skilled in the art.

What is claimed is:

1. A process for producing a plastic-metal composite component, the process comprising
a) providing an injection mold or compression mold with at least one openable cavity and a mold dimension A in a closure direction and a mold dimension B at right angles to the closure direction of the mold and a cavity circumference UW corresponding to a circumference of the at least one openable cavity in the region of mold dimensions A and B, with at least two slide gates or at least two core pullers, arranged in such that the two open ends of a hollow profile are closed by travel of the at least two slide gates or at least two core pullers, or closure elements that are provided in c) and introduced into the two open ends in d) are blocked from being pushed away from the two open ends of the hollow profile by the plastic to be applied in j),
b) providing at least one hollow profile made of metal with a ratio of diameter to wall thickness in a range from 5:1 to 300:1, an outer dimension C of which is greater by a range of 0.1% to 5% than the mold dimension A, and an outer dimension D of which is smaller by a range of 0.1% to 5% than the mold dimension B, and figures for C and D are based on 90° viewed in a direction toward a longitudinal axis of the hollow profile, and the hollow profile circumference UH of which corresponds to the cavity circumference UW of the at least one injection mold or compression mold cavity specified in a),
c) providing at least two closure elements,
d) introducing the closure elements provided in c) and hence sealing the two open ends of the hollow profile,
e) introducing a fluid through openings into the at least one hollow profile that has been sealed after d) through at least one of the at least two closure elements and deaerating an interior of the hollow profile,
f) inserting the hollow profile that has been sealed after e) into the at least one cavity of the injection mold or compression mold provided in a),
g) supporting the at least two closure elements that close the two ends of the hollow profile by means of the at least two slide gates or the at least two core pullers on a mold side,
h) closing the at least one cavity of the injection mold or compression mold and pressing the hollow profile by a mold closure movement in a closure direction of the at least one cavity to change the shape of the hollow profile in that the outer surface of the hollow profile, after the end of the mold closure operation, corresponds to an inner shape of the cavity of the injection mold or compression mold provided in a) in the region of contact surfaces at axial ends of the at least one cavity, while the hollow profile circumference UH remains equal to the cavity circumference UW,
i) locking the at least two slide gates or the at least two core pullers and hence simultaneously blocking the at least two closure elements provided in c) from being pushed away from the open ends of the hollow profile by the plastic to be applied in j),
j) externally applying an application of plastic in the form of a melt at a pressure in a range from 1 bar to 1000 bar to the hollow profile,
k) cooling the application of plastic applied to the hollow profile in i),
l) removing the finished composite component from the injection mold or compression mold, and
m) removing the at least two closure elements and emptying the fluid out of the hollow profile provided with the application of plastic.

2. The process according claim 1, wherein a form-fitting bond of the hollow profile and the application of plastic is achieved radially in all directions about a center axis of the hollow profile and rotationally at right angles to the center axis of the hollow profile.

3. The process according to claim 1, wherein a bond of the hollow profile and the application of plastic is achieved with the blocking of all degrees of freedom, by translation in X, Y and Z direction and by rotation about the X, Y and Z axis, by means of a surface treatment of an outer wall of the hollow profile.

4. The process according to claim 3, wherein the surface treatment selected is from at least one of an application of at least one adhesion promoter, a plasma surface activation, a laser structuring, a chemical pretreatment and an additive manufacturing method.

5. The process according to claim 4, wherein means of the chemical pretreatment conducted is use of acids or bases and the additive manufacturing method conducted is the thermal metal spray application method.

6. The process according to claim 1, wherein the hollow profile is filled with the fluid and/or the fluid is emptied out of the hollow profile prior to l) in the injection mold or compression mold.

7. The process according to claim 1, wherein d) and e) are conducted within the injection mold or compression mold, wherein the at least two closure elements are part of the injection mold or compression mold in the form of the at least two slide gates or the at least two core pullers that seal the hollow profile which is still open on both sides in f).

8. The process according to claim 1, wherein, in e), a fluid is introduced until 100% of a volume of the interior of the hollow profile has been filled therewith.

9. The process according to claim 1, wherein the hollow profile, apart from the openings to be closed by the at least two closure elements at the top ends, does not have any further openings, bores or holes.

10. The process according to claim 1, wherein, after l), the hollow profile is deformed at at least one position by action of additional flexural forces.

11. The process according to claim 1, wherein, before f) or during one of f), g) or h), the hollow profile is deformed at at least one position by action of additional flexural forces.

12. The process according to claim 11, wherein said deforming is effected outside the mold at a desired position in the hollow profile.

13. The process according to claim 1, wherein the hollow profile to be provided in b) has structural elements or fins on its outside.

14. The process according to claim 1, wherein the fluid is an incompressible hydraulic fluid.

15. The process according to claim 14, wherein the fluid used comprises oil-in-water emulsions or solution products having a water content of more than 80% or concentrates based on mineral oil or based on soluble polyglycols, water-in-oil emulsions having a water content of more than 40%, or mineral oil, or water glycols having a water content exceeding 35% or polyglycol solution, or anhydrous synthetic liquids having a higher density than mineral oil or water.
